(19) United States
(12) Patent Application Publication
(10) Pub. No.: US 2026/0138052 A1
(43) Pub. Date: May 21, 2026

(54) SYSTEM AND METHOD OF ON-SITE EXCHANGE OF SORBENT MEDIA INTO A LARGE MOBILE ADSORBER VESSEL

(71) Applicant: CALGON CARBON CORPORATION, Moon Township, PA (US)

(72) Inventor: Martin O'BRIEN, Moon Township, PA (US)

(73) Assignee: CALGON CARBON CORPORATION, Moon Township, PA (US)

(21) Appl. No.: 19/389,434

(22) Filed: Nov. 14, 2025

Related U.S. Application Data
(60) Provisional application No. 63/720,968, filed on Nov. 15, 2024.

(51) Int. Cl. B01D 15/10

(52) U.S. Cl. CPC B01D 15/10

(57) ABSTRACT

Mobile adsorber vessels for the filtering of fluids and methods of using the same are disclosed. The methods include providing a mobile adsorber vessel with a sorbent media in an amount of about 10 tons to about 16 tons and filtering chemicals from a fluid using the sorbent media. The method further includes removing the sorbent media from the mobile adsorber vessel by one of vacuum removal or slurry exchange.

### CROSS-REFERENCE TO RELATED APPLICATIONS

This application claims benefit of and priority to U.S. Provisional Patent Application No. 63/720,968 titled “SYSTEM AND METHOD OF ON-SITE EXCHANGE OF SORBENT MEDIA INTO A LARGE MOBILE ADSORBER VESSEL” filed November 15, 2024, the disclosure of which is incorporated by reference herein in its entirety.

### BACKGROUND

Solid sorbent media, such as granular activated carbon (GAC), are used for various filtration applications (for example, water, air, and/or liquid chemical). In such applications, the sorbent media are contained within a vessel through which fluid flows across the sorbent media. In this process, chemical compounds are concentrated on the sorbent media until its capacity has been reached, at which point the spent sorbent media must be replaced with new media that has capacity for the targeted compounds. The replacement of sorbent media is often accomplished in one of two ways: removal and replacement of the spent sorbent media from the vessel at the location of filtration using fixed equipment, or removal and replacement of the entire adsorber vessels using mobile equipment where the spent media and vessel are transported to an off-site location for removal and replacement.

Mobile adsorbers are distinct from fixed adsorbers in that they are designed to be transported over the road on a specialized trailer that erects and places the mobile adsorber upright on delivery. Large mobile adsorber vessels are typically 8-12 ft diameter adsorbers rated between 0.5-10 bar max pressure that typically contain between 5-8 T of sorbent media.

Typically, large mobile adsorber vessels are size-limited as determined by the expected weight of spent media to allow the entire vessel and media to travel over the road. In the United States, the road weight limit is 40 short tons (T). For delivery of a large mobile adsorber by road transit in the U.S., there exists approximately 16 T of sorbent media payload capacity determined by the balance of weight available after factoring in the tractor, trailer, and empty adsorber weights. There exists a need for improvements in mobile adsorber vessels and replacement of spent sorbent media specifically from a large mobile adsorber.

### SUMMARY

In one embodiment, a method for the filtration of chemical compounds from a fluid includes providing a mobile adsorber vessel comprising fresh sorbent media, wherein the mobile adsorber vessel comprises a conical bottom with an angle of about 30 degrees to about 60 degrees; providing a fluid comprising the chemical compounds; passing the fluid into the mobile adsorber vessel through an influent hose operably connected to the mobile adsorber vessel; filtering the chemical compounds from the fluid using the sorbent media; removing the filtered fluid from the mobile adsorber vessel through an effluent hose operably connected to the mobile adsorber vessel; and removing the sorbent media from the mobile adsorber vessel.

In some embodiments, removing the sorbent media from the mobile adsorber vessel comprises removing the sorbent media from the mobile adsorber vessel by one of slurry exchange or vacuum removal.

In some embodiments, the mobile adsorber vessel further comprises a discharge port configured to allow for the removal of the sorbent media from the mobile adsorber vessel.

In some embodiments, removing the filtered fluid from the mobile adsorber vessel comprises closing the effluent hose; opening the discharge port; and pressurizing the mobile adsorber vessel by a flushing hose operably connected to a top of the mobile adsorber vessel.

In some embodiments, the fresh sorbent media is provided in an amount of about 10 tons to about 16 tons.

In some embodiments, the mobile adsorber vessel comprises a conical bottom with an angle of about 45 degrees.

In some embodiments, the fresh sorbent media comprises one or more of carbonaceous char, activated carbon, reactivated carbon, carbon black, natural zeolite, synthetic zeolite, silica, silica gel, alumina, alumina clay, zirconia, diatomaceous earths, and metal oxides.

In some embodiments, the mobile adsorber vessel comprises the fresh sorbent media in an amount of about 10 tons.

In some embodiments, the mobile adsorber vessel comprises one or more manways dimensioned to allow a user equipped with an oxygen device to enter the mobile adsorber vessel.

In one embodiment, a mobile adsorber vessel for the filtration of chemical compounds from a fluid includes an influent hose operably connected to a top of the mobile adsorber vessel and configured to allow a fluid to enter the mobile adsorber vessel; an effluent hose operably connected to a bottom of the mobile adsorber vessel and configured to allow a fluid to exit the mobile adsorber vessel; and a discharge port operably connected to the bottom of the mobile adsorber vessel and configured to allow a sorbent media to be removed from the mobile adsorber vessel, wherein the bottom of the mobile adsorber vessel is conical with an angle of about 30 degrees to about 60 degrees.

In some embodiments, the effluent hose is configured to be closed during removal of the sorbent media from the mobile adsorber vessel.

In some embodiments, the mobile adsorber vessel further comprises a flushing hose operably connected to the top of the mobile adsorber vessel and configured to provide a flushing fluid into the mobile adsorber vessel.

In some embodiments, the discharge port is configured to be connected to a vacuum to allow for vacuum removal of sorbent media from the mobile adsorber vessel.

In some embodiments, the mobile adsorber vessel is configured to hold a fresh sorbent media in an amount of about 10 tons to about 16 tons.

In some embodiments, the mobile adsorber vessel is configured to hold a fresh sorbent media in an amount of about 12 tons.

In some embodiments, the conical bottom portion of the mobile adsorber vessel has an angle of about 45 degrees.

In some embodiments, the mobile adsorber vessel further comprises one or more manways dimensioned to allow a user equipped with an oxygen device to enter the mobile adsorber vessel.

In one embodiment, a system for transporting a mobile adsorber vessel includes a truck configured to hold a mobile adsorber vessel; and a mobile adsorber vessel securely attached to the truck, the mobile adsorber vessel including: an influent hose operably connected to a top of the mobile adsorber vessel configured to allow a fluid to enter the mobile adsorber vessel, an effluent hose operably connected to a bottom of the mobile adsorber vessel configured to allow a fluid to exit the mobile adsorber vessel, and a discharge port operably connected to the bottom of the mobile adsorber vessel configured to allow a sorbent media to be removed from the mobile adsorber vessel, wherein the bottom of the mobile adsorber vessel is conical with an angle of about 30 degrees to about 60 degrees.

In one embodiment, the system has a total mass of less than about 40 tons.

### BRIEF DESCRIPTION OF DRAWINGS

FIGS. 1 and 2 depict diagrams of illustrative mobile adsorber vessels in accordance with embodiments.

FIG. 3 depicts a diagram of an illustrative system for transporting a mobile adsorber vessel in accordance with an embodiment.

FIG. 4 depicts a flow diagram of an illustrative method of filtering chemical compounds from a fluid in accordance with an embodiment.

FIGS. 5 and 6 depict flow diagrams of illustrative methods of removing spent carbon from a mobile adsorber vessel in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

As used herein, the term “fresh sorbent media” means a sorbent material that contains sorbent capacity. For example, a fresh sorbent media may comprise a virgin activated carbon.

As used herein, the term “spent sorbent media” means a sorbent material that has used all or essentially all of its sorbent capacity.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of "comprising" various components or steps (interpreted as meaning "including, but not limited to"), the compositions, methods, and devices can also "consist essentially of" or "consist of" the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of "two recitations," without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 compounds. Similarly, a group having 1-5 compounds refers to groups having 1, 2, 3, 4, or 5 compounds, and so forth.

### DETAILED DESCRIPTION

This disclosure is not limited to the particular systems, devices, and methods described, as these may vary. The terminology used in the description is for the purpose of describing the particular versions or embodiments only and is not intended to limit the scope.

### Systems

Systems can be assembled to aid in the filtration of chemical compounds from a fluid. Such a system may comprise a mobile adsorber vessel configured to hold a fresh sorbent media. The mobile adsorber vessel may comprise an influent hose operably connected to the top of the mobile adsorber vessel and configured to allow a fluid to enter the mobile adsorber vessel and an effluent hose operably connected to the bottom of the mobile adsorber vessel and configured to allow a fluid to exit the mobile adsorber vessel. The mobile adsorber vessel may further comprise a discharge port operably connected to the bottom of the mobile adsorber vessel and configured to allow a sorbent media to be removed from the mobile adsorber vessel. In some embodiments, the mobile adsorber vessel comprises a conical bottom. The conical bottom may enable a user to remove the sorbent media from the mobile absorber vessel by slurry discharge and vacuuming.

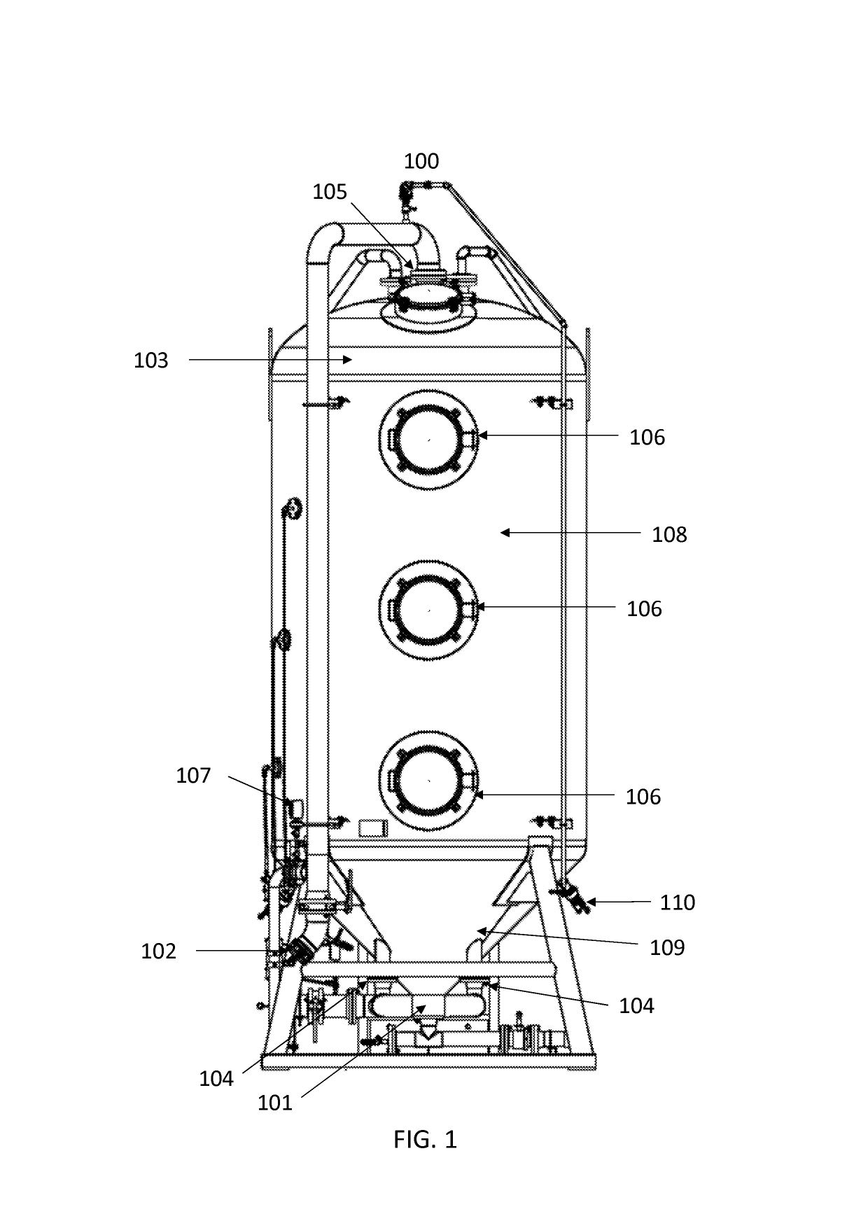

FIG. 1 depicts a diagram of a front side of an illustrative mobile adsorber vessel 100. The mobile adsorber vessel 100 comprises a main tank 108 configured to hold sorbent media. In some embodiments, the main tank 108 is configured to hold fresh sorbent media in an amount of about 8 tons, about 8.5 tons, about 9 tons, about 9.5 tons, about 10 tons, about 10.5 tons, about 11 tons, about 11.5 tons, about 12 tons, about 12.5 tons, about 13 tons, about 13.5 tons, about 14 tons, about 14.5 tons, about 15 tons, about 15.5 tons, about 16 tons, or any value or range of values between any two of these values. In some embodiments, the main tank 108 is configured to hold fresh sorbent media in an amount of about 8 tons to about 16 tons, about 10 tons to about 16 tons, or about 10 tons to about 12 tons.

The mobile adsorber vessel 100 comprises an influent hose 102 operably connected to the main tank 108 and configured to allow a fluid to enter the main tank 108. In some embodiments, the influent hose 102 is connected to the main tank 108 at the top 103 of the main tank 108. In some embodiments, the system comprises a nozzle 105 operably connected to the influent hose 102 and configured to control fluid flow within the influent hose 102. In some embodiments, the nozzle 105 is configured to move between an open position and a closed position to control fluid flow within the influent hose 102. In some embodiments, the influent hose 102 is configured to be attached to an external source configured to provide the fluid to the influent hose 102. The influent hose 102 may be configured to attach to an external source by any mechanism known to one of skill in the art. In some embodiments, the influent hose 102 comprises a quick connect coupling. In some embodiments, the influent hose 102 comprises a one-way valve configured to allow flow from the influent hose 102 into the main tank 108 and restrict flow from the main tank 108 into the influent hose 102. In some embodiments, the one-way valve is positioned in the nozzle 105.

In some embodiments, the mobile adsorber vessel 100 comprises an effluent hose 101 operably connected to the main tank 108 and configured to allow a fluid to exit the main tank 108. In some embodiments, the effluent hose 101 is connected to the main tank 108 at the bottom 109 of the main tank 108. In some embodiments, the system comprises a plurality of nozzles 104 operably connected to the effluent hose 101 and configured to control fluid flow within the effluent hose 101. In some embodiments, each of the plurality of nozzles 104 is operably connected to the main tank 108 and configured to allow the fluid to exit the main tank 108 and enter the effluent hose 101. In some embodiments, the plurality of nozzles 104 comprise 2, 3, 4, 5, 6, 7, or 8 nozzles. In some embodiments, each of the plurality of nozzles 104 is configured to move between an open position and a closed position to control fluid flow within the effluent hose 101. In some embodiments, the effluent hose 101 is configured to be attached to an external source configured to receive the fluid from the effluent hose 101. In some embodiments, the external source may be one of a disposal unit or a recycling unit. The effluent hose 101 may be configured to attach to an external source by any mechanism known to one of skill in the art. In some embodiments, the effluent hose 101 comprises a quick connect coupling. In some embodiments, the effluent hose 101 comprises at least one one-way valve configured to allow flow from the main tank 108 into the effluent hose 101 and restrict flow from the effluent hose 101 into the main tank 108. In some embodiments, the at least one one-way valve is positioned in each of the plurality of nozzles 104. In some embodiments, the at least one one-way valve is positioned between each of the plurality of nozzles 104 and the main tank 108.

In some embodiments, the effluent hose 101 comprises an anti-siphon loop to prevent fluid from entering the main tank 108 from the effluent hose 101. In some embodiments, the anti-siphon loop comprises a pipe beginning at the bottom of the mobile adsorber vessel 100, extending upwards above the top of the main tank 108, and ending at the bottom of the main tank 108. In some embodiments, the mobile adsorber vessel 100 comprises an air release operably connected to the anti-siphon loop and configured to allow air to enter the anti-siphon loop to prevent fluid from entering the mobile adsorber vessel 100 from the effluent hose 101.

In some embodiments, the mobile adsorber vessel 100 comprises a plurality of manways 106 configured to enable a user to clean the mobile adsorber vessel 100. The mobile adsorber vessel 100 may comprise any number of manways 106. In some embodiments, the plurality of manways 106 comprises 2, 3, 4, 5, or 6 manways. In some embodiments, one or more of the plurality of manways 106 may be positioned on the top of the main tank 108. In some embodiments, each of the plurality of manways 106 may be dimensioned to allow a user equipped with an oxygen device to enter the main tank 108. In some embodiments, a user may enter before, during, or after the vacuuming of the main tank 108 to remove spent sorbent media. To avoid suffocation due to the activated carbon, the user may be equipped with an oxygen device. As such, at least one of the plurality of manways 106 may be dimensioned to allow the user and the oxygen device to enter the main tank 108.

In some embodiments, the mobile adsorber vessel 100 further comprises a pressure release valve 107 configured to reduce the pressure within the main tank 108. In some embodiments, the pressure release valve 107 is operably connected to the main tank 108.

In some embodiments, the mobile adsorber vessel 100 comprises a fluid spray line 110. The fluid spray line 110 is connected to one or more internal fluid spray nozzles (not shown). When a fluid, such as water, is pumped or otherwise pushed into the fluid spray line 110, it flows through the fluid spray line 110 and exits one or more internal fluid spray nozzles. The one or more internal fluid spray nozzles are positioned within the main tank 108. When the fluid exits the one or more internal fluid spray nozzles inside the main tank 108, the fluid is sprayed throughout the main tank 108 and contacts, and thereby carries, any remaining residual sorbent media from the walls of the main tank 108 towards the bottom of the main tank 108. In this way, the mobile adsorber vessel 100 is configured to be fluidly emptied in an automated fashion by spraying. In these embodiments, although the mobile adsorber vessel 100 is provided with a plurality of manways 106, the entire mobile adsorber vessel 100 can be emptied of sorbent without a person, such as a user or other technician, entering the mobile adsorber vessel 100. Though a single fluid spray line 110 is depicted in FIG. 1, it will be understood by skilled persons that more than one fluid spray line 110 and associated internal fluid spray nozzles can be attached to or otherwise associated with mobile adsorber vessel 100.

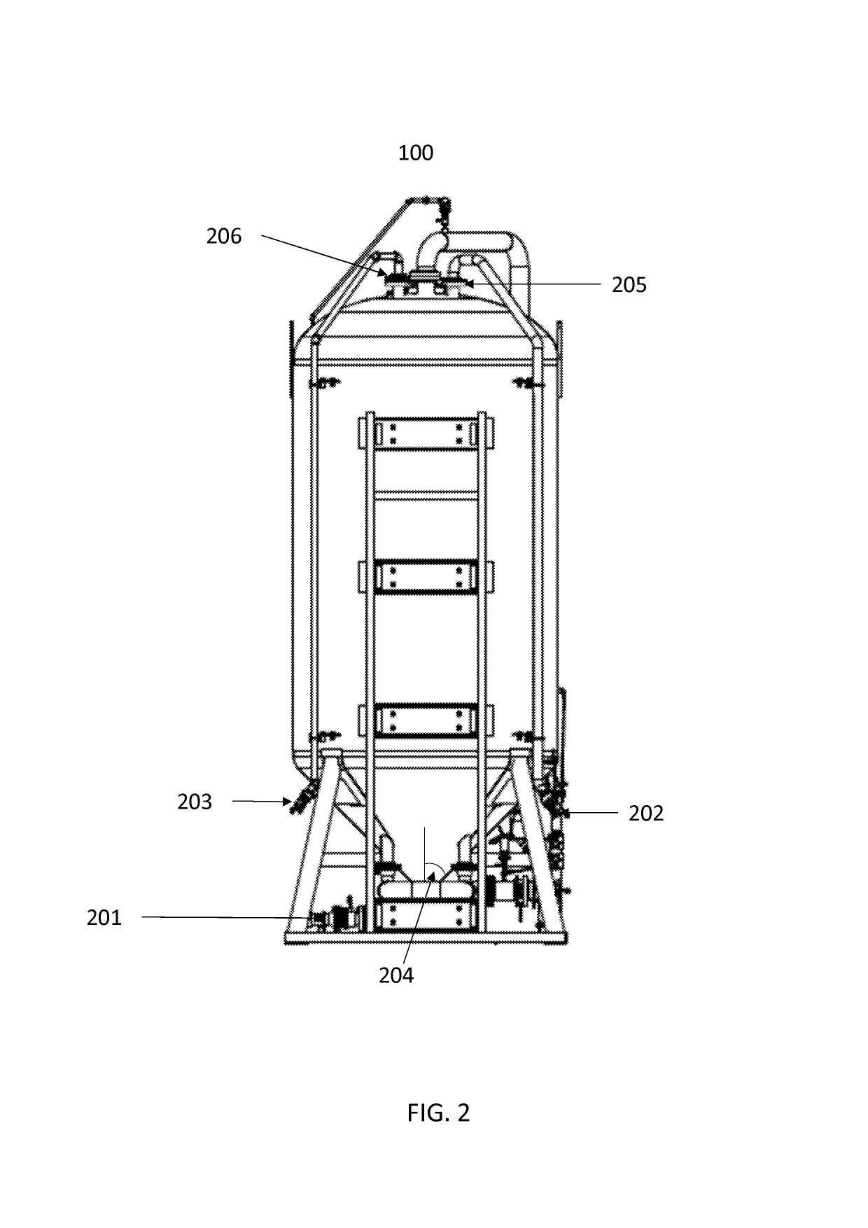

FIG. 2 depicts a diagram of a back side of an illustrative mobile adsorber vessel 100. In some embodiments, the mobile adsorber vessel 100 comprises a discharge port 201 operably connected to the main tank 108 and configured to allow a sorbent media to be removed from the mobile adsorber vessel 100. In some embodiments, the discharge port 201 is operably connected to the bottom 109 of the main tank 108. In some embodiments, the discharge port 201 is configured to be attached to a vacuum to enable a user to remove the sorbent media by vacuum removal. In some embodiments, the discharge port 201 is configured to move from a closed position to an open position to enable the removal of sorbent media from the mobile adsorber vessel 100. In some embodiments, the main tank 108 comprises a conical bottom 109, and the discharge port 201 is positioned at a vertex of the conical bottom 109. In some embodiments, the discharge port 201 is configured to be attached to an external source configured to receive the sorbent media from the discharge port 201. In some embodiments, the external source may be one of a disposal unit or a recycling unit. The discharge port 201 may be configured to attach to an external source by any mechanism known to one of skill in the art. In some embodiments, the discharge port 201 comprises a quick connect coupling. In some embodiments, the discharge port 201 comprises a one-way valve configured to allow flow from the main tank 108 into the discharge port 201 and restrict flow from the discharge port 201 into the main tank 108.

In some embodiments, the mobile adsorber vessel 100 comprises a flushing hose 202 configured to provide a flushing fluid into the main tank 108. In some embodiments, the flushing hose 202 is operably connected to the top 103 of the main tank 108. In some embodiments, the system comprises a flushing nozzle 205 configured to control the flow of fluid from the flushing hose 202 to the main tank 108. In some embodiments, the flushing nozzle 205 is configured to move between an open position and a closed position to control fluid flow within the flushing hose 202. In some embodiments, the flushing hose 202 is configured to be attached to an external source configured to provide the flushing fluid to the flushing hose 202. In some embodiments, the flushing fluid is compressed air, and the flushing hose 202 is configured to enable the main tank 108 to be pressurized. The flushing hose 202 may be configured to attach to an external source by any mechanism known to one of skill in the art. In some embodiments, the flushing hose 202 comprises a quick connect coupling. In some embodiments, the flushing hose 202 comprises a one-way valve configured to allow flow from the flushing hose 202 into the main tank 108 and restrict flow from the main tank 108 into the flushing hose 202. In some embodiments, the one-way valve is positioned in the flushing nozzle 205.

In some embodiments, the mobile adsorber vessel 100 comprises a water spray hose 203 configured to provide water into the main tank 108. In some embodiments, the spray hose 203 is operably connected to the top 103 of the main tank 108. In some embodiments, the system comprises a water spray nozzle 206 configured to control the flow of fluid from the spray hose 203 to the main tank 108. In some embodiments, the water spray nozzle 206 is configured to move between an open position and a closed position to control fluid flow within the spray hose 203. In some embodiments, the spray hose 203 is configured to be attached to an external source configured to provide the water to the spray hose 203. The spray hose 203 may be configured to attach to an external source by any mechanism known to one of skill in the art. In some embodiments, the spray hose 203 comprises a quick connect coupling. In some embodiments, the spray hose 203 comprises a one-way valve configured to allow flow from the spray hose 203 into the main tank 108 and restrict flow from the main tank 108 into the spray hose 203. In some embodiments, the one-way valve is positioned in the water spray nozzle 206.

In some embodiments, the mobile adsorber vessel 100 comprises a hatch configured to enable the mobile adsorber vessel 100 to be filled with a sorbent media. In some embodiments, the hatch is positioned on the top of the main tank 108. In some embodiments, the hatch is positioned on a side of the main tank 108. In some embodiments, the hatch is configured to move from a closed position to an open position to enable the mobile adsorber vessel 100 to be filled with a sorbent media.

In some embodiments, the bottom 109 of the mobile adsorber vessel 100 is shaped. The bottom 109 of the main tank 108 may comprise any shape effective for the removal of sorbent media from the main tank 108. In some embodiments, the bottom 109 comprises a conical shape. The conical bottom 109 may comprise any angle 204 effective for the removal of sorbent media from the main tank 108. In some embodiments, the angle 204 is measured from a vertical plane to a side of the conical bottom 109. In some embodiments, the conical bottom 109 has an angle 204 of about 30 degrees, about 35 degrees, about 40 degrees, about 45 degrees, about 50 degrees, about 55 degrees, about 60 degrees, about 65 degrees, about 70 degrees, about 75 degrees, or any value or range of values between any two of these values. In some embodiments, the conical bottom 109 has an angle of about 30 degrees to about 60 degrees.

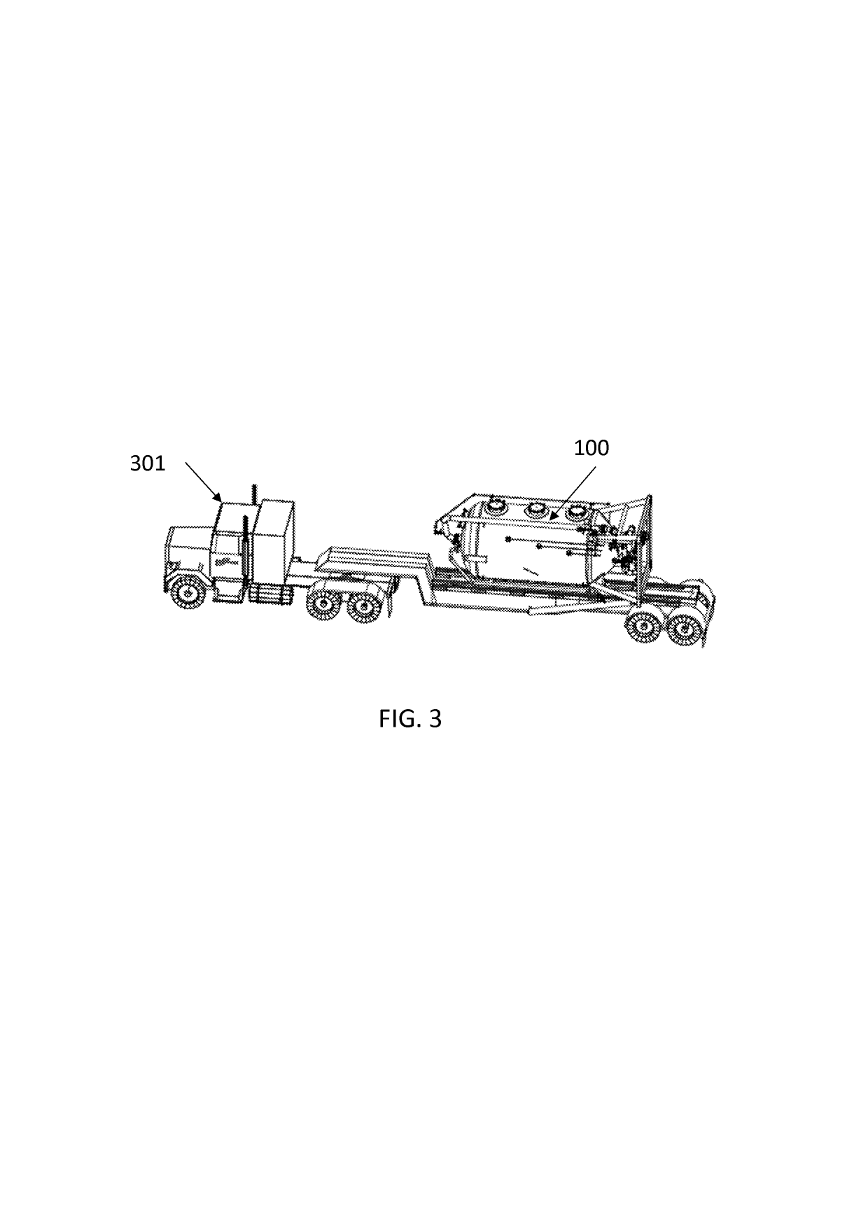

FIG. 3 depicts a diagram of an illustrative system for transporting a mobile adsorber vessel 100. The system comprises a truck 301 and a mobile adsorber vessel 100 securely connected to the truck 301. The mobile adsorber vessel 100 may be securely connected to the truck 301 by any means known to one of skill in the art. In some embodiments, the mobile adsorber vessel 100 is securely connected to the truck 301 by a hook positioned on the truck 301 and operably connected to the mobile adsorber vessel 100. In some embodiments, the mobile adsorber vessel 100 is securely connected to the truck 301 by one or more of chains, ropes, straps, tarps, netting, clamps, hooks, shackles, blocking and bracing, or d-rings.

In some embodiments, the mobile adsorber vessel 100 comprises a fresh sorbent material. In some embodiments, the mobile adsorber vessel 100 comprises a fresh sorbent material in an amount of about 8 tons, about 8.5 tons, about 9 tons, about 9.5 tons, about 10 tons, about 10.5 tons, about 11 tons, about 11.5 tons, about 12 tons, about 12.5 tons, about 13 tons, about 13.5 tons, about 14 tons, about 14.5 tons, about 15 tons, about 15.5 tons, about 16 tons, or any value or range of values between any two of these values. In some embodiments, the main tank 108 is configured to hold a fresh sorbent media in an amount of about 8 tons to about 16 tons, about 10 tons to about 16 tons, or about 10 tons to about 12 tons. In some embodiments, the system for transporting a mobile adsorber vessel 100 has a total mass of less than about 40 tons.

### Methods

Methods can be assembled to filter chemical compounds from a fluid using the above-described mobile adsorber vessels.

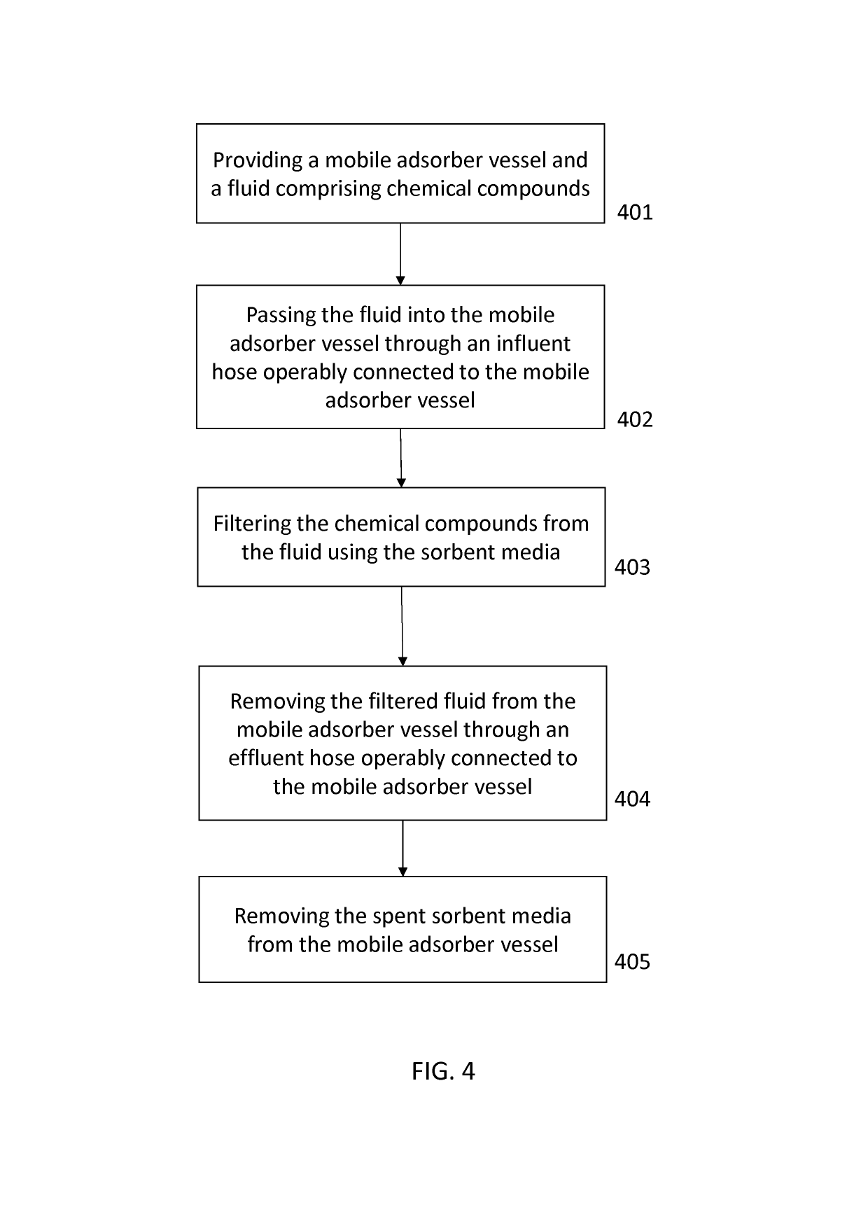

FIG. 4 depicts a flow diagram of an illustrative method of filtering chemical compounds from a fluid. The method may comprise providing 401 a mobile adsorber vessel comprising fresh sorbent media in an amount of about 8 tons to about 12 tons and a fluid comprising the chemical compounds. The fresh sorbent media may be any sorbent material effective for the removal of chemicals from fluids known to one of skill in the art. In some embodiments, the fresh sorbent media comprises one or more of carbonaceous char, activated carbon, reactivated carbon, carbon black, natural zeolite, synthetic zeolite, silica, silica gel, alumina, alumina clay, zirconia, diatomaceous earths, and metal oxides. In some embodiments, the fresh sorbent media is provided in an amount of about 8 tons, about 8.5 tons, about 9 tons, about 9.5 tons, about 10 tons, about 10.5 tons, about 11 tons, about 11.5 tons, about 12 tons, about 12.5 tons, about 13 tons, about 13.5 tons, about 14 tons, about 14.5 tons, about 15 tons, about 15.5 tons, about 16 tons, or any value or range of values between any two of these values. In some embodiments, providing 401 the mobile adsorber vessel comprises delivering the mobile adsorber vessel using a truck.

The method may further comprise passing 402 the fluid into the mobile adsorber vessel. In some embodiments, the fluid is passed 402 into the mobile adsorber vessel through an influent hose operably connected to the mobile adsorber vessel.

The method may further comprise filtering 403 the chemical compounds from the fluid using the sorbent media and removing 404 the filtered fluid from the mobile adsorber vessel. In some embodiments, the filtered fluid is removed 404 from the mobile adsorber vessel 100 through an effluent hose operably connected to the mobile adsorber vessel.

The method may further comprise removing 405 the spent sorbent media from the mobile adsorber vessel. The spent sorbent media may be removed 405 from the mobile adsorber vessel by any method known to one of skill in the art. In some embodiments, the spent sorbent media is removed 405 from the mobile adsorber vessel by one of slurry exchange or vacuum removal.

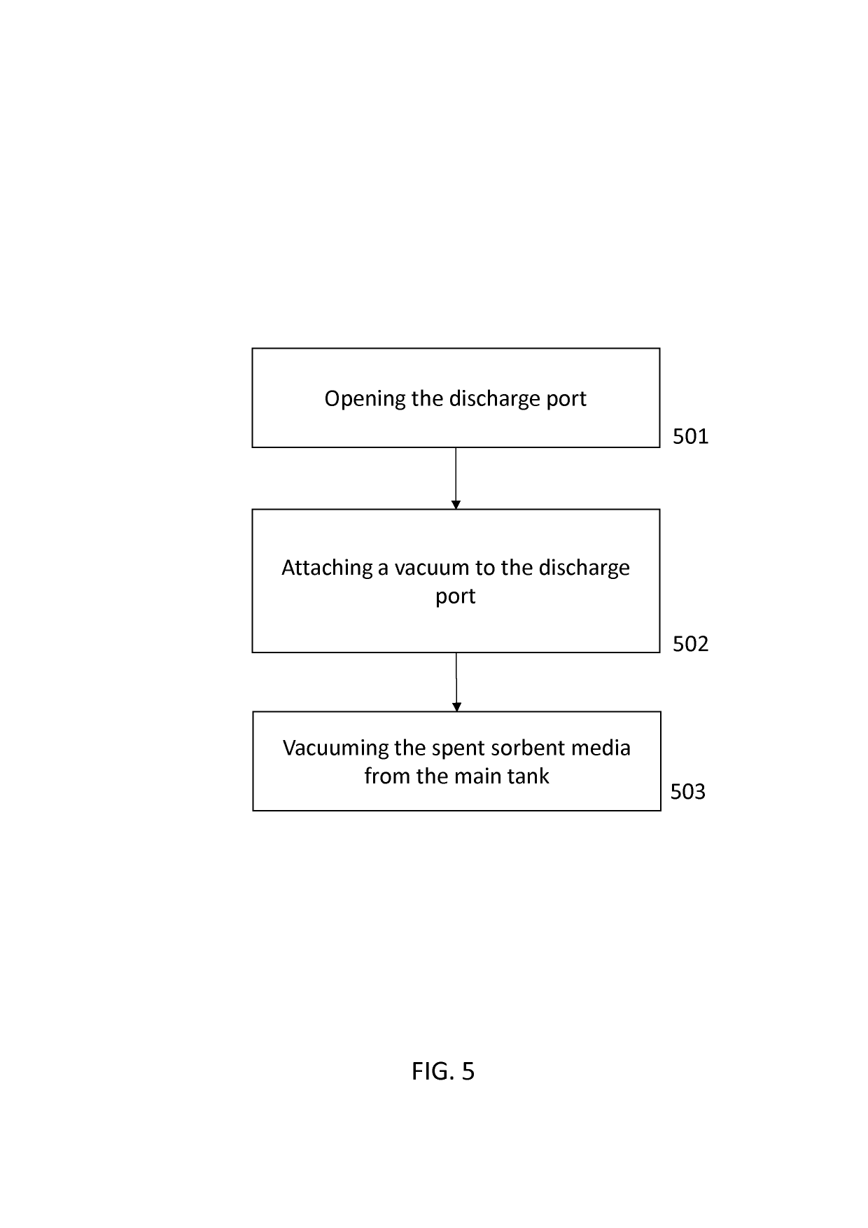

FIG. 5 depicts a flow diagram of an illustrative method of vacuum removal. In some embodiments, the vacuum removal method comprises opening 501 the discharge port 201 and attaching 502 a vacuum to the discharge port 201. In such an embodiment, the method may further comprise vacuuming 503 the spent sorbent media from the main tank 108. In some embodiments, the method comprises opening at least one nozzle 104/105/205/206.

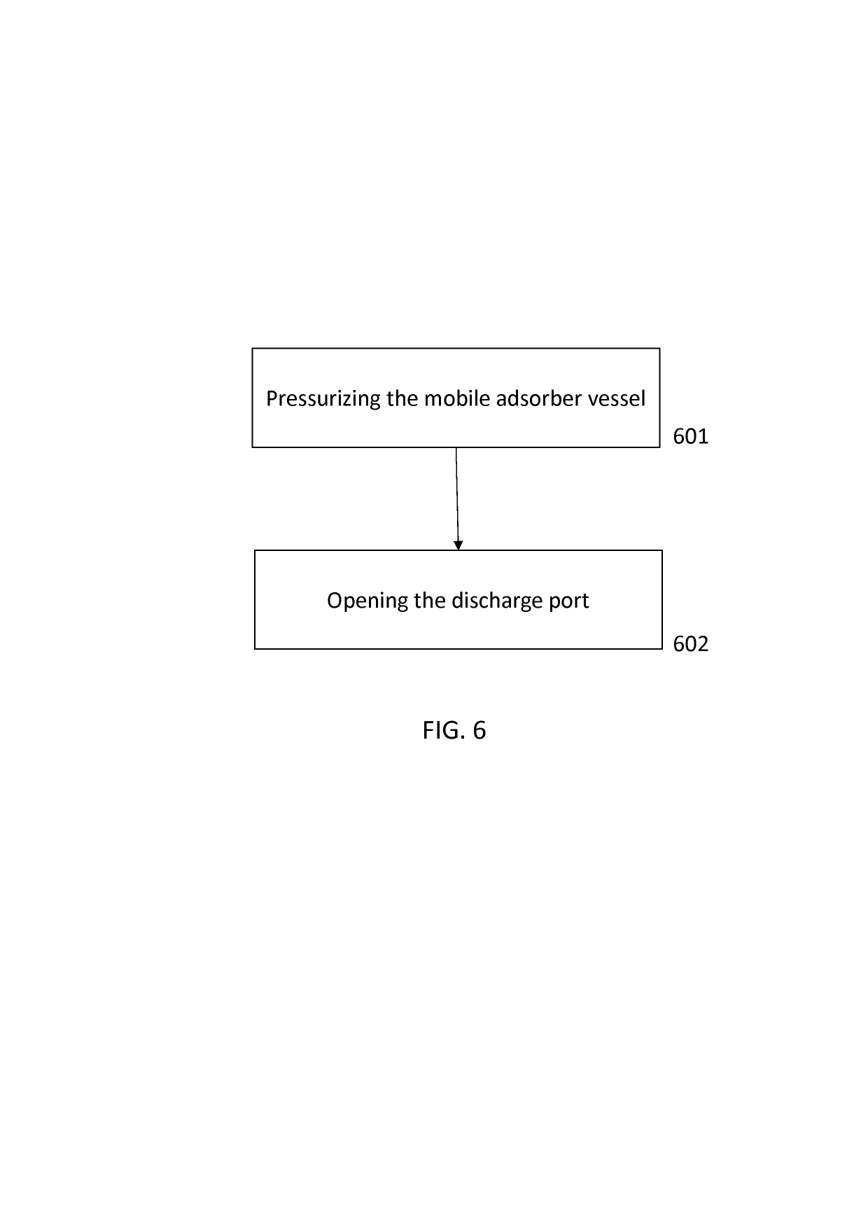

FIG. 6 depicts a flow diagram of an illustrative method of slurry exchange. In some embodiments, a slurry exchange method comprises pressurizing 601 the mobile adsorber vessel and opening 602 the discharge port to remove 405 the spent sorbent media from the mobile adsorber vessel. In some embodiments, pressurizing the mobile adsorber vessel comprises closing the nozzles 104/105/206. In some embodiments, the method comprises opening the discharge port 201 and the flushing nozzle 205. In some embodiments, the method comprises closing the effluent hose 101. In some embodiments, the method further comprises attaching a compressed air source to the flushing hose 202 and pressurizing the main tank 108 of the mobile adsorber vessel 100 using the compressed air. Pressurizing the main tank 108 may force the spent sorbent media to flow out of the main tank 108 through the discharge port 201. In some embodiments, the spent sorbent media and the filtered fluid are removed from the main tank 108 simultaneously.

The main tank 108 may be pressurized to any pressure effective for the removal of the spent sorbent media from the main tank 108. In some embodiments, the main tank 108 is pressurized to a pressure of about 20 psig, about 25 psig, about 30 psig, about 35 psig, about 40 psig, about 45 psig, about 50 psig, about 55 psig, about 60 psig, about 65 psig, about 70 psig, about 75 psig, about 80 psig, about 85 psig, about 90 psig, about 95 psig, about 100 psig, about 105 psig, about 110 psig, about 115 psig, about 120 psig, 125 psig, about 130 psig, about 135 psig, about 140 psig, about 145 psig, about 150 psig, or any value or range of values between any two of these values.

In some embodiments, the method further comprises adding a second fresh sorbent media to the main tank 108. The second fresh sorbent media may be any sorbent material effective for the removal of chemicals from fluids known to one of skill in the art. In some embodiments, the second fresh sorbent media comprises one or more of carbonaceous char, activated carbon, reactivated carbon, carbon black, natural zeolite, synthetic zeolite, silica, silica gel, alumina, alumina clay, zirconia, diatomaceous earths, and metal oxides. In some embodiments, the second fresh sorbent media is provided in an amount of about 8 tons, about 8.5 tons, about 9 tons, about 9.5 tons, about 10 tons, about 10.5 tons, about 11 tons, about 11.5 tons, about 12 tons, about 12.5 tons, about 13 tons, about 13.5 tons, about 14 tons, about 14.5 tons, about 15 tons, about 15.5 tons, about 16 tons, or any value or range of values between any two of these values.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method for the filtration of chemical compounds from a fluid, the method comprising:
providing a mobile adsorber vessel comprising fresh sorbent media, wherein the mobile adsorber vessel comprises a conical bottom with an angle of about 30 degrees to about 60 degrees;
providing a fluid comprising the chemical compounds;
passing the fluid into the mobile adsorber vessel through an influent hose operably connected to the mobile adsorber vessel;
filtering the chemical compounds from the fluid using the sorbent media;
removing the filtered fluid from the mobile adsorber vessel through an effluent hose operably connected to the mobile adsorber vessel; and
removing the sorbent media from the mobile adsorber vessel.

2. The method of claim 1, wherein removing the sorbent media from the mobile adsorber vessel comprises removing the sorbent media from the mobile adsorber vessel by one of slurry exchange or vacuum removal.

3. The method of claim 1, wherein the mobile adsorber vessel further comprises a discharge port configured to allow for the removal of the sorbent media from the mobile adsorber vessel.

4. The method of claim 3, wherein removing the filtered fluid from the mobile adsorber vessel comprises:
closing the effluent hose;
opening the discharge port; and
pressurizing the mobile adsorber vessel by a flushing hose operably connected to a top of the mobile adsorber vessel.

5. The method of claim 1, wherein the fresh sorbent media is provided in an amount of about 10 tons to about 16 tons.

6. The method of claim 1, wherein the mobile adsorber vessel comprises a conical bottom with an angle of about 45 degrees.

7. The method of claim 1, wherein the fresh sorbent media comprises one or more of carbonaceous char, activated carbon, reactivated carbon, carbon black, natural zeolite, synthetic zeolite, silica, silica gel, alumina, alumina clay, zirconia, diatomaceous earths, and metal oxides.

8. The method of claim 1, wherein the mobile adsorber vessel comprises the fresh sorbent media in an amount of about 10 tons.

9. The method of claim 1, wherein the mobile adsorber vessel comprises one or more manways dimensioned to allow a user equipped with an oxygen device to enter the mobile adsorber vessel.

10. A mobile adsorber vessel for the filtration of chemical compounds from a fluid, the mobile adsorber vessel comprising:
an influent hose operably connected to a top of the mobile adsorber vessel and configured to allow a fluid to enter the mobile adsorber vessel;
an effluent hose operably connected to a bottom of the mobile adsorber vessel and configured to allow a fluid to exit the mobile adsorber vessel; and
a discharge port operably connected to the bottom of the mobile adsorber vessel and configured to allow a sorbent media to be removed from the mobile adsorber vessel,
wherein the bottom of the mobile adsorber vessel is conical with an angle of about 30 degrees to about 60 degrees.

11. The mobile adsorber vessel of claim 10, wherein the effluent hose is configured to be closed during removal of the sorbent media from the mobile adsorber vessel.

12. The mobile adsorber vessel of claim 10, further comprising a flushing hose operably connected to the top of the mobile adsorber vessel and configured to provide a flushing fluid into the mobile adsorber vessel.

13. The mobile adsorber vessel of claim 10, wherein the discharge port is configured to be connected to a vacuum to allow for vacuum removal of sorbent media from the mobile adsorber vessel.

14. The mobile adsorber vessel of claim 10, wherein the mobile adsorber vessel is configured to hold a fresh sorbent media in an amount of about 10 tons to about 16 tons.

15. The mobile adsorber vessel of claim 10, wherein the mobile adsorber vessel is configured to hold a fresh sorbent media in an amount of about 12 tons.

16. The mobile adsorber vessel of claim 10, wherein the conical bottom portion of the mobile adsorber vessel has an angle of about 45 degrees.

17. The mobile adsorber vessel of claim 10, further comprising one or more manways dimensioned to allow a user equipped with an oxygen device to enter the mobile adsorber vessel.

18. A system for transporting a mobile adsorber vessel, the system comprising:
a truck configured to hold a mobile adsorber vessel; and
a mobile adsorber vessel securely attached to the truck, the mobile adsorber vessel comprising:
an influent hose operably connected to a top of the mobile adsorber vessel configured to allow a fluid to enter the mobile adsorber vessel,
an effluent hose operably connected to a bottom of the mobile adsorber vessel configured to allow a fluid to exit the mobile adsorber vessel, and
a discharge port operably connected to the bottom of the mobile adsorber vessel configured to allow a sorbent media to be removed from the mobile adsorber vessel,
wherein the bottom of the mobile adsorber vessel is conical with an angle of about 30 degrees to about 60 degrees.

19. The system of claim 18, wherein the system has a total mass of less than about 40 tons.
